(19) United States
(12) Patent Application Publication
(10) Pub. No.: US 2004/0241627 A1
(43) Pub. Date: Dec. 2, 2004

(54) Method & system for providing orientation/training and controlling site access

(76) Inventor: Raymond Delfing, Columbus, NJ (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/804,519

(22) Filed: Mar. 19, 2004

Related U.S. Application Data
(60) Provisional application No. 60/456,688, filed on Mar. 21, 2003.

(51) Int. Cl. G09B 19/00; G09B 7/00

(52) U.S. Cl. 434/219; 434/362; 434/350

(57) ABSTRACT

A computer aided training and certification method and system is provided that also serves to control jobsite access. A hosting center/central network stores multimedia content and administrative/certification information and communicates with training units to deliver the training and instructional scripts directed to site and task specific requirements and records trainee responses to inquiries and test questions. Site access is limited to only those qualified for the purpose and satisfying mandatory pre-employment safety orientations, including testing, and/or to only those having a pre-determined purpose for entry through system generated identification cards, administrative computer tracking and/or site located electronic card readers. Individual qualification, upon entry and for use in permitting entry, is also provided for a cataloging of those individuals/employees on site and identifying those on site by the skills and tasks to which they are qualified and/or certified.

### RELATED INVENTIONS

This application claims benefit of U.S. Provisional Application Serial No. 60/456,688, filed Mar. 21, 2003, entitled “METHOD AND SYSTEM FOR PROVIDING ORIENTATION/TRAINING AND CONTROLLING SITE ACCESS,” which is incorporated herein, in its entirety, by this reference.

### FIELD OF THE INVENTION

The present invention relates to the field of interactive electronic methods and systems for providing orientation, training and certification of employees, and for controlling employee access to a jobsite. More particularly, the present invention relates to methods and systems for interactive computer-aided orientation, training and certification that provides instruction using multimedia content and obtains feedback from a plurality of trainees via a computer network.

### BACKGROUND OF THE INVENTION

Business entities are often required, by law or prudent policy, to provide training to their employees regarding safe, efficient, or otherwise required procedures for performing assigned duties. For instance, government agencies often require employers in certain fields to not only provide particular types of periodic training to employees, but also require those employers to routinely certify that each employee has received the mandated training, has demonstrated a threshold understanding of the material, and/or has agreed to comply with the requirements. More particularly, the Occupational Safety and Health Administration requires employers in certain high risk industries to regularly certify that employees in certain positions possess adequate understanding of applicable safety regulations. Further, various state and local jurisdictions impose similar requirements upon various occupational fields. In addition, owners/managers of certain plant or site locations, who do not directly employ the individuals characterized above, may nonetheless face liability if any of these individuals do not receive, understand, and/or agree to comply with applicable safety regulations, or required job orientation, training and/or certification procedures.

Traditionally, business entities attempted to satisfy the above occupational training requirements in an instructor led, lecture type classroom environment. In this instance, the instructor provided the required site specific or task specific subject matter, probably through lecture directed to distributed hard-copy materials, and concluded the training with testing to determine whether the employees retained the requisite knowledge, and/or understood and agreed to comply with the required site or job specific safety procedures.

As employees may be tasked to perform various jobs and/or report to any number of jobsites over various days, weeks, or months, practical realities make it difficult to ensure that required site specific and task specific training and certifications are maintained at all times, and that all employees remain compliant. The necessity to coordinate and schedule traditional instructor orientation, training and testing further frustrates this objective.

Accordingly, what is needed is a method and system to conveniently provide the required orientation, training, and/or certifications necessary for each site specific or task specific duty a potential employee may be assigned. Further, the method and system must efficiently track the training and certifications held by each employee, provide notifications of re-training requirements as imposed by company policy or government requirement, and be instrumental in controlling plant and/or site access to only those satisfying all requisite requirements.

### SUMMARY OF THE INVENTION

The present invention is an interactive, web-based personnel orientation, training and certification method and system to be presented to and satisfied by those desiring access and/or employ at any one or more physical locations and/or project sites under control of a specific entity. The present invention can be used to control access to site locations to only those qualified for the purpose, to only those satisfying mandatory pre-employment safety orientations and/or certification requirements, including testing, and/or to only those having a pre-determined purpose for entry. The present invention also provides for a qualification of the individual, upon entry and for use in permitting entry, while also providing for a cataloging of those individuals/employees on site and identifying those on site by the skills and tasks to which they are qualified and/or certified.

The present invention can be delivered by a hosting center server, providing convenient scalability to any number of site locations for access at that location to the orientation/certification product, or to the databases created by and associated with the product. In one embodiment, the present invention provides the orientation/certification product using video, text, still photography, and animation, all via the web, with many portions or modules concluding with one or more questions or problems eliciting a response, whereby the responses, of the plurality of examinees/trainees, is communicated to a monitor and/or recorder for incorporation into the database. Upon successful completion of the training, trainee information is recorded in a database of individuals authorized for employment for a specific task, or authorized for employment at a specific site location, and an identification card is generated for the individual noting the respective authorizations.

In one embodiment of the present invention, the method and system is used for orientation of contractors hired by Waste Management, Inc., to perform any number of services at various Waste Management sanitation related sites, such as landfills and transfer stations. In one aspect, the orientation program will provide contractor employees with an understanding of the hazards present at the landfill facilities, and of the mandatory and/or recommended policies and procedures in place for the safety/protection of the contractor employees, the Waste Management employees, and/or the other consultants and visitors. Successful completion of the safety orientation could be required on a yearly basis, with the database tracking and communicating deadlines for renewal to the individual employees.

### BRIEF DESCRIPTION OF THE DRAWINGS

For the purpose of illustrating the embodiments of the present invention, there is shown in the drawings forms presently preferred; it being understood, however, that the present invention is not limited to the precise arrangements and instrumentalities shown:

FIG. 1 illustrates schematically one embodiment of a system for providing orientation/training and site access control, showing the relative location and interaction of components of the system, namely a hosting center and client devices/training units, jobsites, administrative computers, badging computers, and card readers;

FIG. 2 is a flow diagram illustrating an orientation/training method in accordance with one embodiment of the present invention, detailing how an employee receives the orientation/training and satisfies certification testing;

FIG. 3 illustrates an interface whereby a participant is registered for the orientation/training in accordance with one embodiment of the present invention;

FIG. 4 illustrates a segment of multimedia content incorporated into a training script in accordance with one embodiment of the present invention, whereby the trainee is required, at pre-determined intervals, to respond to inquiries regarding the content received;

FIG. 5 illustrates an orientation print-out, in accordance with one embodiment of the present invention; that is generated at the conclusion of training and includes a combination registration form, confirmation signature/employee declaration page, and a temporary identification card;

FIG. 6 is a report, generated in accordance with one embodiment of the present invention, illustrating orientation results for a single individual, the report showing how the individual responded to each question, if the individual disagreed with a question, and how many times the individual disagreed with the question prior to agreeing; and

FIG. 7 is a report, generated in accordance with one embodiment of the present invention, listing employees, arranged by company (i.e., the employee's direct employer), that have successfully completed training and are permitted entry to jobsites, the report including a listing of the permitted jobsites.

### DETAILED DESCRIPTION OF ILLUSTRATIVE EMBODIMENTS

A personnel orientation, training and certification method and system is presented for those desiring access and/or employ at any one or more physical locations and/or project sites under control of a specific entity.

The Orientation/Training System

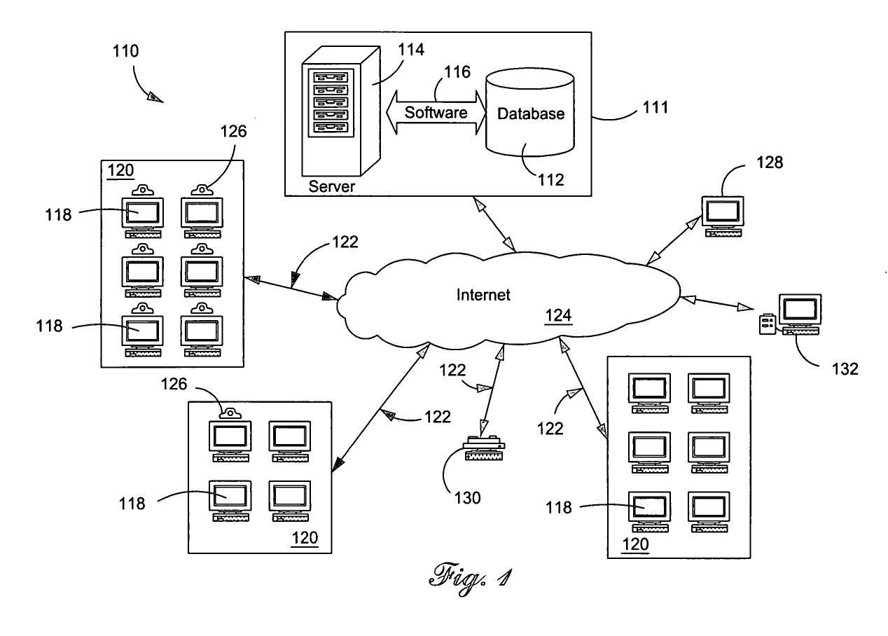

In one embodiment of the present invention, as shown in FIG. 1, the system 110 for providing orientation/training and site access control includes a central network 111 with an electronically accessible storage medium (database) 112, at least one server 114, and software 116 operated by the server 114. The system 110 also includes multiple remote client devices 118 (such as personal computers or workstations); the client devices 118 serving as automated training, qualification, and/or certification units that communicate electronically with the central network 111. The client devices 118 are arranged into groups, as necessary, at training centers or jobsites 120. A prospective employee could receive orientation, training and certification applicable to any site location or job task at any one of the training centers or jobsites 120.

The server 114 could number one or more, the server(s) 114 supporting electronics commonly used in the industry to provide remote networking and/or web-serving platforms, running a viable operating system. The storage medium 112 is electronically connected to the server(s) 114, perhaps by a local area network (“LAN”). The storage medium 112 includes one or more databases designed to hold certification results data and related administration information (identifying, for example, the employee/trainee, the training centers 120, and the client devices 118 from which the data originated. Each database in the storage medium 112 may store its data in any manner known in the art, such as directly on a server hard drive, or remotely on external storage media including tape drives, CD-RWs and writable optical disks, and remote hard drives.

The software 116 running on the central network server 114 is adapted to receive the registration information, test results, and/or relevant qualification facts for each participant/trainee electronically from the client devices 118, while storing this information on one or more databases of the storage media 112. Further, the server software 116 accepts queries from site administrators, located at various training centers or jobsites 120, requesting electronic access to the registration and/or qualification results database 112. The central network 111 electronically communicates 122 with the client devices 118 and the site facilitators over local or distributed networks, such as the Internet 124, to update and access database 112 information. The data delivered and stored can comprise any desirable combination of information deemed relevant to the trainee's/employee's certification status (employee name or ID, certification types, date last trained or certified, scores or performance on tests, number of training sessions taken to pass, number of attempts to correctly answer a particular question, overall pass/fail rates, etc.).

The client devices/training units 118, located at various training centers/remote site locations 120, can each include a visual display, a central processing unit, memory, audio delivery device, and a means for entering data by the participant/trainee during the periodic training and qualification of employees or contractors. The means for entering data could be a keyboard, mouse, touch screen, pad, or device, or the like. The individual training units 118 could also include a camera 126 to photograph the trainee during orientation and training, and subsequently store the identity of the participant/trainee for later use, such as for delivery during generation of an identification card for the authorized trainee.

The series of client devices/training units 118 are adapted to provide instruction to employees/trainees (one trainee per unit), test the trainees regarding the instruction, and/or receive the trainee's agreement to abide by certain requirements, and upload the pertinent information (i.e., trainee responses and other information) pertaining to successful completion, or non-completion, of the orientation and/or testing process into the centralized searchable database 112 located on the central network 111. Upon receipt by the server 114, from a given client device/training unit 118, the data is loaded into the appropriate database 112 such that trainee responses and the current certification status of each trainee/employee can be electronically monitored, searched, and instantaneously sorted by persons (administrators) having appropriate administrative authority and access to the data.

The storage medium 112 of the central management network 111 associates an administrative access profile with all administrative, training and certification results data transferred from the training units 118 to facilitate management of the stored results data. The administrative access profile defines parameters that determine what administrative persons or entities can obtain electronic access to the results data, whether for a particular trainee/employee, for trainees/employees working at a particular site, on a particular task, and/or for a particular employer entity having employees registered in the system 111. The administrative access profiles also determine authorization of management personnel to edit, override, or otherwise govern the results data and/or site access authorization.

For example, in one embodiment of the invention, there may be three levels of administrative authorization. The first, a site administrator, would have authority to pre-register and register on-site, trainees for the orientation, and have authority to provide or govern the orientation. The second, a senior site administrator, would have the authorities of the site administrator, plus the authority to access reports data, to generate any number of reports, and to edit the administrative and results data. The third, a super administrator, would have all of the authorities of the first two administrators, plus the authority to lock out a trainee (discussed below).

HTML front-end tools (e.g., ASP or CGI scripts) could be incorporated within the server software 116 to accommodate SQL databases not being directly accessible over the Internet 124. Accordingly, the front-end tools operate as extensions of the server software 116, allowing administrators to generate reports or displays of the results data from remote administrative computers 128 or client devices/training units 118 using web browser applications connected to the central management network 111 over the Internet 124. In this embodiment, the server software 116 and its HTML front-end tools communicate with an appropriate database 112 via SQL or other suitable data access languages to access the results data as requested by an administrator having proper authorities.

The participant/trainee is provided instruction with multimedia content, such as video, text, audio, still photography, and/or animation, providing training information specifically pertaining to the job or task for which the participant/trainee requires certification, including, if necessary, information specific to the trainee's work site, such as any particular hazards, safety requirements, or special work conditions. After each portion, or module of instruction (e.g., a series of video/audio clips), the system prompts the user to answer several queries regarding the module. A module, and/or a complete orientation/training session, is complete only when the participant/trainee views all of the modules of orientation/training content and successfully answers all or an adequate number of test questions.

In an embodiment of the present invention, personnel will not be granted employ, or site access, without verification that the orientation/certification process has been successfully completed. Verification can occur through use of an identification card generated at the completion of training, or through security/site administrator investigation of a database listing those who successfully viewed the orientation/certification presentation and have successfully completed any testing/certification requirements.

The database 112 includes all of the individual's pertinent information, his or her test results, and all security information. Additional information can also be included and tracked, such as personnel employment history, health concerns, accident record, and/or security violations. The system allows administrators to generate reports and track individuals, not only regarding successful completion of the training, but also ongoing employment status. Further, the database provides a profile for the individual, enabling quick access to pertinent information in the event of an incident or accident.

In one embodiment of the invention, the database 112 is further linked to a security identification (e.g., badging) method and system. Those successfully completing the orientation/certification process would have their qualifying information, including administrative information, test results and certification qualifications, available to a security badging computer 130 located at any of the individual sites (i.e., at the individual site access control location). The server 114 communicates necessary qualifying information to the security badging computer 130, authorizing the badging computer 130 to create an identification/security card for the individual. The badge identifies the individual's qualifications, certifications, good standing, and/or limitations of site access. Limitations to site access could include a range of time allowed on site, specific locations of permitted access on site, etc., all based upon prior training and certification testing.

The individual presents this identification card at the job site upon each request for entry at the site location. The card could be viewed by security personnel stationed at a site entry point, or monitored by an electronic card reader 132 or scanning device located at the site entry point. The identification card could incorporate a magnetic strip, bar code, computer chip, or other means for identifying the individual and/or communicating with the central network 111 to verify employee authorization to enter the job site and/or perform the specific task.

In addition to monitoring the qualification/security information of the individual, the server 114 could further communicate to the site locations, for visual display or audio presentation at the electronic card reader 132, a schedule of where (i.e., which site location) the individual employee, consultant, or visitor is expected, when they are expected, and for what purpose they are expected, thereby providing site access control administrators with a tool to better secure the site, and better control the work occurring thereon. Further, the scanning device or card reader 132 could record to a database located either on site or at the central network 111, the site location entered by the individual, the time of entry, the time of exit, etc. Still further, pertinent information (e.g. expiration of a badge and the associated deadline for renewal of registration through completion of another orientation/training session) can be communicated to the individual upon a scanning of the badge during site entry.

The Orientation/Training Method

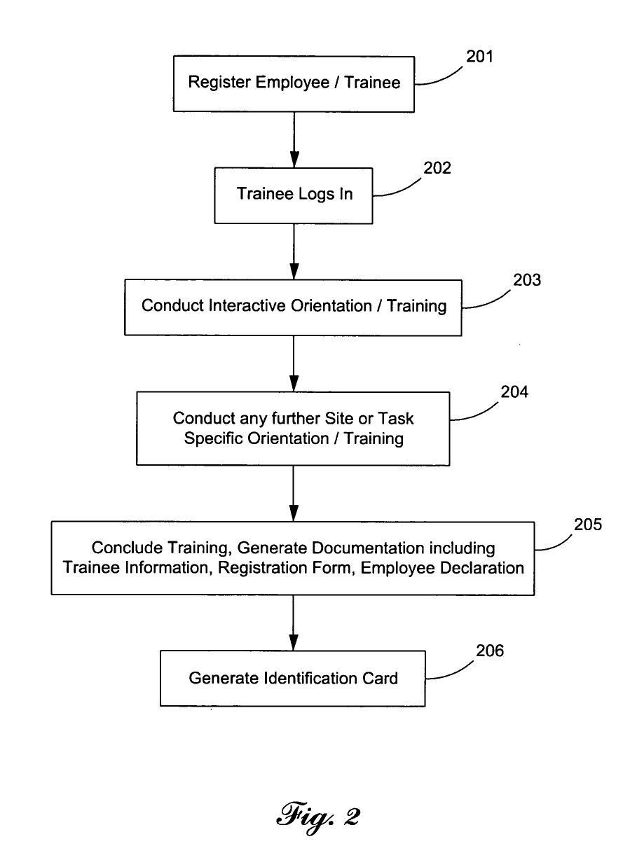

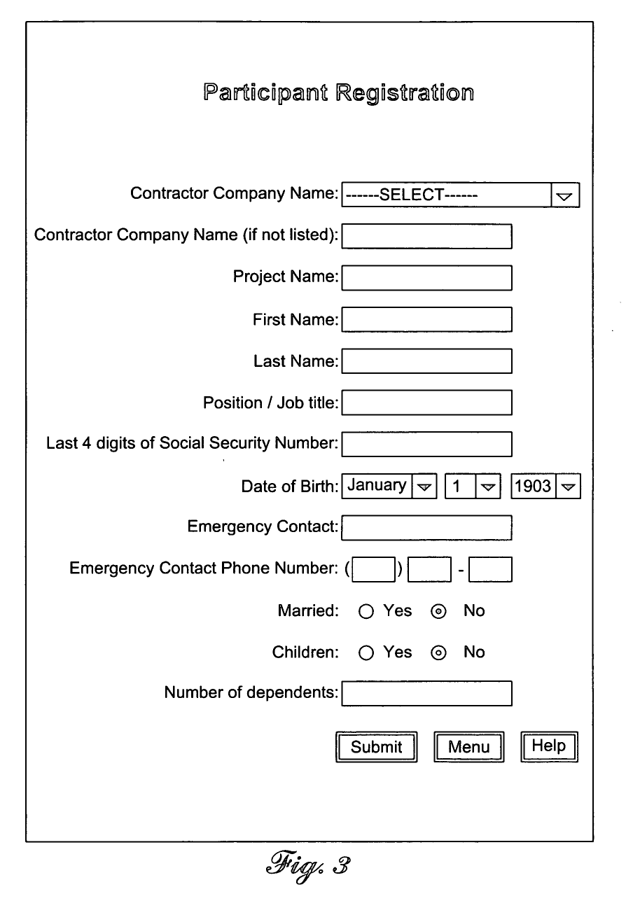

FIG. 2 illustrates a flow diagram depicting the orientation/training method, detailing how an employee receives the orientation/training and satisfies certification testing according to embodiments of the present invention. First, each prospective employee is registered 201, which can be accomplished in at least three ways. A contractor, or employee representative, can provide an orientation facilitator (e.g., a jobsite manager) with required information for each employee/trainee, and the orientation facilitator will pre-register each employee/trainee electronically. Or, the contractor, or employee representative, can pre-register each contractor employee/trainee via the Internet on a web site created specifically for this purpose. An example registration page for either of the above registration methods is illustrated in FIG. 3. Finally, the employee/trainee can register at any site location (e.g., training center 120) at any time prior to, or immediately prior to, taking the orientation.

The prospective employee then logs-in 202 upon arrival at the training center or jobsite 120. Prior to initiating training, an orientation facilitator might have accessed the central network 111, perhaps over the Internet 124, with a remote computer 128 and web browser and identified what training sessions and certifications are needed by a particular employee (or group of employees). Access via the Internet 124 to the central network 111 can be limited to, by password or otherwise, to any pre-determined number of sites, and can be programmed as not accessible to locations such as a contractor's, or employee representative's (e.g., union) office. Such limitations and/or controls on accessibility would ensure that each individual employee/trainee successfully completes (on his own and without assistance) the orientation/training session.

The prospective employee is asked for identification, and then logs in 202 to a training unit 118 to take the required orientation and training session(s). In the log in step 202, by way of example, the trainee would be prompted to identify himself by entering one or more identifiers (last name, social security number, employer, etc.) before the training unit 118 software would permit access to any customized interactive training and certification content. Optionally, these identifiers could be compared with a master list or roster stored locally on, or made electronically accessible to, each training unit 118 to prevent unauthorized access by persons outside of a particular company or organization as well as to manage what training and certification sessions are taken.

After logging in 202, the trainee may be prompted to select the appropriate training and certification session to receive. After making this selection, or if this selection is not necessary, the interactive orientation/training begins 203. Each training unit 118, as described above, receives the customized training and certification content (preferably in the form of job specific and site-specific multi-media content such as video files). Each of the units 118 at a given training center 120, however, can be adapted to provide interactive sessions, or other materials, for employees having a plurality of job types and working at a plurality of work sites. By defining various training and certification sessions, a single training unit can be used for various types of employees (e.g., ones that require training for hazardous chemical shipping as well as general waste handling) simply by associating each employee/trainee with a given subset of training sessions. Further, depending on the training required, a portion of the training content may originate from the central network 111, may be locally stored on individual training units 118, or may originate from an intermediary computer system, located between one or more training units 118 and the central network 111.

Next, the interactive web based orientation, training and testing 203 begins. The session is divided into modules, with each module usually beginning with an introduction that typically provides a summary of module content. After the introduction, the interactive software outputs the first section of instructional content. As described above, this instructional content is customized to a particular task, worksite, hazard, or responsibility in which the trainee seeks certification. Again, the instructional content includes multi-media files in the form of audio clips, video clips, and audio-visual animations of the actual task, worksite, and/or hazard. In this manner, the particular nuances and requirements of each task or worksite can be understood for compliance with applicable regulations and protocols, and can be easily explained and understood by trainees without necessitating further field training.

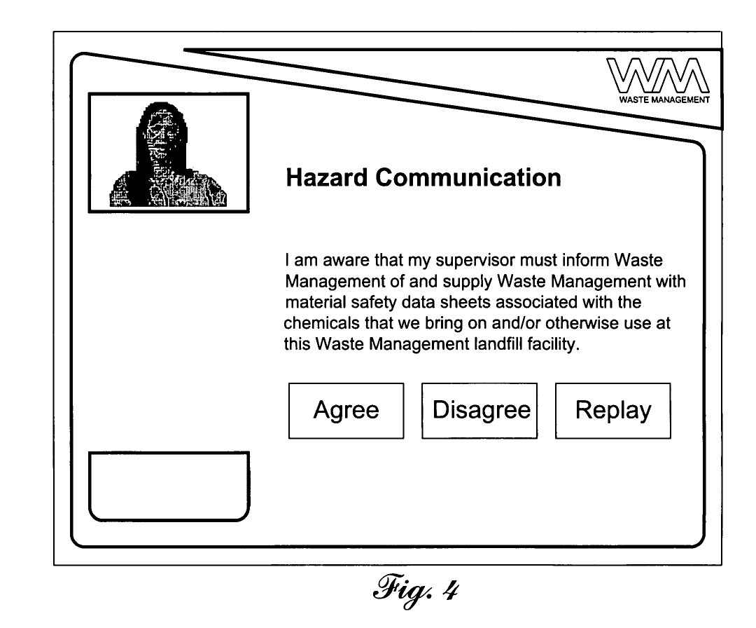

After receiving the first module, or at other pre-selected points during the orientation/training, the employee/trainee is asked to respond to statements indicating that they understand and/or agree with the statement's content and will adhere to the policies, procedures, rules and/or regulations contained in the statement. In one embodiment of the invention, the trainee is required, at each pre-selected interval, to select one of the following three options: agree; disagree; or replay. An example is illustrated in FIG. 4. The participant/trainee progresses through the orientation/training by continuing to receive content and provide responses to inquiries.

Alternatively, the trainee could be more rigorously tested to determine how well the trainee has understood and retained the latest instructional materials. The tests can comprise a series questions, such as multiple choice, matching, true or false, fill in the blank, etc., each directed to important concepts covered in the previous module. In this embodiment, pass/fail determinations could be based on any percentage of correct responses, or could be determined at any interval of training. If a trainee fails a particular interval of training, the software 116 could review the material missed and identify and provide additional materials directed to that topic. Further testing could then be presented to bring the trainee back on course.

In one embodiment of the invention, an inappropriate response to an inquiry causes a replay of the applicable portion of the training session and then provides the participant/trainee with an opportunity to respond to the inquiry again (e.g., FIG. 4). The participant must provide the appropriate response to end the loop and proceed to the next section, module, etc. In another embodiment, providing an incorrect response to a single inquiry three consecutive times results in the employee/trainee being instantaneously locked out of the training session. In this instance, a trainee's selection of replay will not be considered an incorrect response, but a request for further clarification. In the event of lockout, the orientation facilitator may discuss with the trainee the problem, the lack of understanding, or the disagreement to comply with the subject requirement. The orientation facilitator would then determine whether the trainee should continue. A threshold level of administrative authority is required to reinstate the trainee should lock out occur.

Upon conclusion of the web-based interactive orientation, any content locally contained at the training unit 118 can be provided (such as site or task specific training 204), in any form, and with any further required testing. The training unit 118 can generate hard copies of this site or task specific training for immediate study by the trainee and/or for future retention. The orientation facilitator would present these materials, as appropriate, to the participant/trainee. Alternatively, the site/task specific training could include multimedia content delivered from the central network 111. Examples include site/task-specific emergency procedures, contact names, telephone numbers, etc., and site/task-specific safe work practices, work/safety rules, prohibited behaviors, etc. Or, more substantive task specific training with testing could act as certification to demonstrate capability of the individual to perform the specific job task or duty. Upon successful certification for a task, the individual would have the qualifying information recorded in the database, along with the other data, for communication to individual site locations notifying same of the individual's capability and good standing to perform the certifiable task.

At conclusion of orientation/training 205, the trainee's results are immediately available at the hosting center/central network 111, as each trainee response to a question is instantaneously delivered to the central network 111 for processing prior to proceeding to the next interval of multi-media instruction. Upon conclusion, the system 111 generates a registration form, confirmation signature/employee declaration page 205, and an identification card 206.

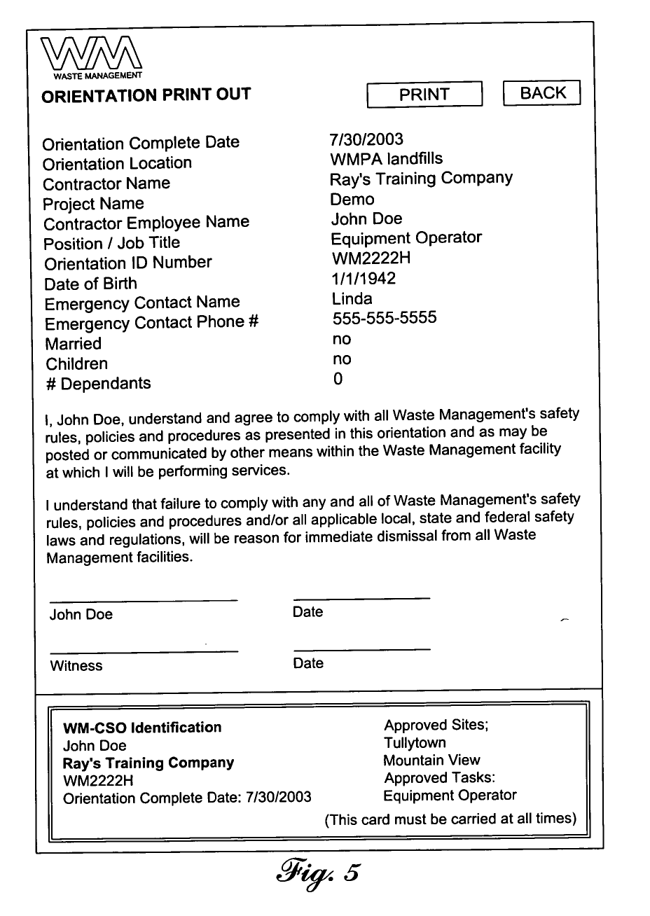

An example of a combination registration form, confirmation signature/employee declaration, and temporary identification card is illustrated in FIG. 5. A hard copy of the individual registration form is placed in the site's contractor/employee file for ease of access during an emergency situation. The registration form can include any or all of the following information:

i. Contractor company name

ii. Project name

iii. Contractor employee personal information

1. Name

2. Position/Title

3. Social security number

4. Date of birth

5. Emergency contact name

6. Emergency contact telephone number

7. Marital status/Dependent information

The employee is asked to sign the confirmation signature/employee declaration page, declaring and indicating that the registration information is accurate and that they agree and will comply with all requirements. The document indicates successful completion of the orientation/training. The executed confirmation signature page can also act as an identification/site access card until a more formal card is generated.

A formal identification card is generated 206 and signed by the employee/trainee and the orientation facilitator. The identification card is required for access to any and all site locations, and to perform services thereon. The card can be updated periodically, perhaps every year, or can be updated upon a change in individual qualification, limitation, or pertinent information. Further, the identification card can serve as the security badge, generated by the security badging computer 130, discussed above. This identification card is presented by the employee upon each request for entry at a job site location. The identification card could be viewed by security personnel stationed at a site entry point, or monitored by an electronic card reader 132 located at the site entry point. The identification card could incorporate a magnetic strip, bar code, computer chip, or other means for identifying the individual and/or communicating with the central network 111 to verify employee authorization to enter the job site and/or perform the specific task.

A system administrator retaining certain authority, as discussed above, located at either the hosting center 111, a training center 120, or at an administrative computer 128, can execute a variety of reports based upon any one or more of the various fields within the registration and/or results database. For example, orientation/training results could be presented, showing overall performance by all trainees for each question, or showing performance for a particular individual. Further, a report of permitted employees arranged by company (employer) name could be presented, or a report of permitted employees arranged by site location, or job task. Also, a list of pre-registered trainees not yet receiving orientation/training, etc., could be generated, or various orientation survey results could be generated, showing survey results by all trainees, survey results by trainees at certain site location, or by trainees working for a particular company/contractor.

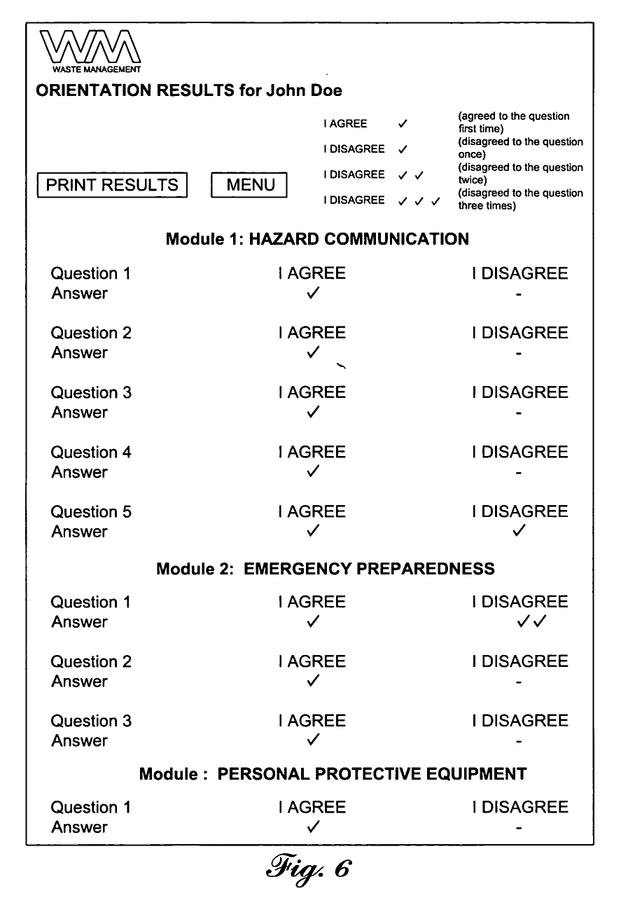

An example of orientation results for a single individual is illustrated in FIG. 6. The report shows how the individual responded to each question, if the individual disagreed with a question, and how many times the individual disagreed with the question prior to agreeing. This type of report has value where an employee later fails to comply, in the field, with a particular requirement. The employee can be shown that during orientation he responded that he understood the requirement and agreed to comply with the requirement.

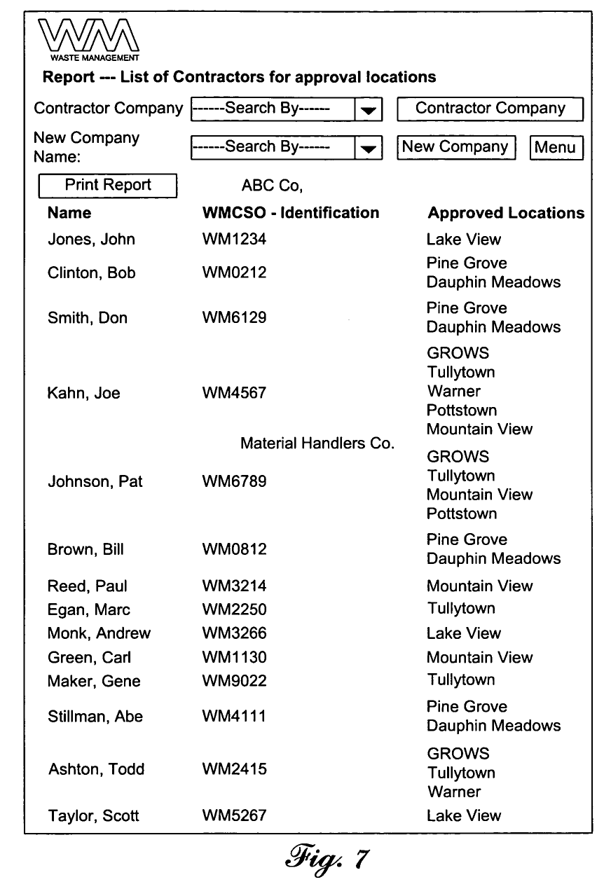

An example of a report of permitted employees arranged by company (i.e., employee's direct employer) is shown in FIG. 7. A jobsite manager or company administrator can view a list of employees of a particular company approved to work, and view a list of sites associated with each of those approvals. If an upcoming project at a particular site requires pre-planned staffing, this list can facilitate that effort by showing whether an adequate number of employees for a given company are approved to work (i.e., received the required training) and are approved to work at the particular site (i.e., also received the site specific training). A review of this list allows for efficient manning of a given job at a particular site, and often results in the jobsite manager being able to request the specific employees of a company/contractor that will staff the given project at a jobsite.

A report of permitted employees arranged by site location, or job task, provides a quick review, by administrative or safety personnel, of available manpower at a given site, or for a given task. If a project requires a certain level of manpower at a given site, this report will inform management whether there are employees available to adequately task the project, and whether those intended to task the project have received and satisfied the orientation/training requirement.

The list of pre-registered trainees not yet receiving orientation/training can be used by managers to ensure that upcoming projects (workload needs) are sufficiently pre-planned, with registrations occurring in advance of work commencement, to adequately provide for the orientation/training requirement. This list could also be arranged and grouped by company/employer.

Orientation survey results, completed by the trainees, provide feedback to the administrator and inform the administrator of the value of the training as judged by the trainee. The surveys also address the level of understanding and manageability of the training to the trainee, and involve other administrative factors that management can use to improve the ease, flexibility, and value of the training. The survey results can be arranged by site location to inform the administrator of any problems or concerns specific to a particular site. The survey results can be presented for a specific individual, or all employees of a particular company, etc., to reveal any values or points of view of the individual(s) that may be of value upon later events occurring during employment.

In one embodiment of the invention, a system administrator having a certain threshold of authority has Site Access Control (a.k.a. Lockout Ability). An employee removed or banned from one or more site locations (e.g., for violation of safety procedures or prohibited behaviors, accident involvement, failure to successfully complete, or keep current, orientation/training requirements, etc.) can be “locked-out” of the system 111 by the system administrator. Should the banned individual attempt to register for the orientation at, or attempt to enter, another site location, the system 111 would disapprove the registration, and deny the individual access to the site location by communicating the individual's status to the inquiring site location.

In another embodiment of the present invention, the orientation/training is specifically directed to an orientation of contractors hired by Waste Management, Inc., to perform various services at one or more Waste Management transfer stations and/or landfills. The orientation is directed to safety requirements, with testing directed to an understanding and acceptance of mandatory and/or recommended safety practices when operating on a Waste Management landfill. The orientation is subdivided into modules, as identified below:

1. Introduction: Presented by Waste Management officers explaining reasons for and purposes of the orientation.

2. Registration Tutorial: Showing the participant/trainee how to register (providing required personal/company/project information).

3. Registration: The participant, Waste Management facilitator, or the Contractor/Employee representative provides the required registration information noted above.

4. Orientation Tutorial: Participants/Trainees are shown how to navigate through the orientation/training product, how to perform or accomplish the requirements of the orientation/training, and are instructed regarding policies of the orientation/training.

5. Introduction to Module Cluster I: Presented by a Waste Management officer, an introduction and outline of the importance and relevance of modules 1 through 4.

6. Module 1: Hazard Communication

7. Module 2: Emergency Preparedness

8. Module 3: Personal Protective Equipment

9. Module 4: Lockout/Tagout

10. Introduction to Module Cluster II: Presented by a Waste Management officer, an introduction and outline of the importance and relevance of modules 5 through 8.

11. Module 5: Prohibited Behaviors

12. Module 6: Heavy Equipment

13. Module 7: Trenching/Excavation

14. Module 8: Confined Space

15. Introduction to Module 9: Presented by a Waste Management officer, an introduction and outline of the importance and relevance of module 9.

16. Module 9: Environmental Compliance and Community Relations

17. Outro: Presented by a Waste Management officer, a recap of the orientation and a conclusion.

These and other advantages of the present invention will be apparent to those skilled in the art from the foregoing specification. Accordingly, it is recognized by those skilled in the art that variations or modifications may be made to the above-described embodiments without departing from the broad inventive concepts of the invention. It is therefore understood that this invention is not limited to the particular embodiments described herein, but is intended to include all possible variations and modifications within the scope and spirit of the invention.

What is claimed is:

1. A method for providing training and for qualifying individuals for employ at and access to one or more site locations, the method comprising the steps of:
receiving registration data directed to one or more participants desiring employ at and access to the one or more site locations and recording the data to a central storage media;
determining a relevant training topic;
providing training directed to the relevant topic;
providing a qualifying interface configured to receive participant input relating to one or more queries directed to the relevant topic;
receiving the participant input relating to the one or more queries and recording the participant input to the central storage media;
transmitting results data evidencing a relative level of participant success to the one or more site locations; and
providing an indication of participant qualification for employment at and access to the one or more site locations, wherein the indication serves to enable the participant entry to the one or more site locations.

2. The method of claim 1, further comprising, after receiving the participant input relating to the one or more queries and before transmitting the results data, evaluating whether the participant input satisfies a predetermined criteria; wherein if the predetermined criteria is not satisfied, providing supplemental or repeated training directed to the relevant topic, including providing one or more supplemental or repeated queries directed to the relevant topic for participant input.

3. The method of claim 1, further comprising the step of transmitting direction to generate a badge or identification card, wherein the direction is based upon a review of the registration and the results data recorded to the central storage media for the participant, whereby the badge or identification card enables the participant to enter the one or more site locations.

4. The method of claim 1, further comprising the step of analyzing the indication serving to enable the participant to enter the one or more site locations, the registration data and the results data recorded to the central storage media and transmitting applicable data relevant to the analysis to the one or more site locations.

5. The method of claim 4, wherein the applicable data relevant to the analysis transmitted to the one or more site locations is an approval or disapproval for participant entry to the one or more site locations.

6. The method of claim 4, wherein the applicable data relevant to the analysis transmitted to the one or more site locations is selected from the group consisting of an approval or disapproval of participant entry to the one or more site locations, an indication of the participant's good standing, an indication of the participant's certifications, and an indication of the participant's limitations while on site.

7. The method of claim 1, further comprising the step of receiving, upon participant access to the one or more site locations, and recording to the central storage media, data selected from the group consisting of a site location identifier for the site location accessed by the participant, a time of entry, a time of exit, and tasks performed.

8. The method of claim 1, wherein providing indication of participant qualification for employment at and access to the one or more site locations occurs with each participant request for entry at the one or more site locations upon a review of the registration and the results data for the participant recorded to the central storage media.

9. The method of claim 1, wherein the relevant training topic is a safety orientation related to work at sanitation sites and the one or more site locations are landfills.

10. The method of claim 9, wherein the participant input related to the one or more queries is directed to an understanding of, and an agreement to comply with, mandatory and recommended safety precautions in place at the landfills.

11. The method of claim 1, wherein the relevant training topic is directed to a specific job skill or task, the queries are directed to testing competence in the specific skill or task, and the indication of participant qualification is a certification allowing the participant to perform the specific skill or task at the one or more site locations.

12. A system for providing training and for qualifying individuals for employ at and access to one or more site locations, the system comprising:
a centralized data store configured to receive, store and transmit general, registration, training, and qualifying data directed to one or more individuals;
server software designed to enforce rules relating to the receipt, storage, and transmission of the general, registration, training, and qualifying data;
a plurality of training units configured to transmit the general, registration, training, and qualifying data, wherein the data is generated and transmitted by the training units after the training units communicate training transmitted from the centralized data store, the training being directed to an employment activity at the one or more site locations, at least one of the training units being remotely located from the centralized data store;
a plurality of network clients configured to receive the general, registration, training, and qualifying data from the centralized data store, the clients being operable upon direction of one or more site facilitators;
a first set of network connections providing communication between the centralized data store and the plurality of training units; and
a second set of network connections providing communication between the centralized data store and the plurality of network clients.

13. The system of claim 12, wherein the qualifying data is directed to successful completion of a safety orientation, the remote locations are the site locations, and the site locations are sanitation sites.

14. The system of claim 12, wherein the employment activity is safety rules and precautions and the data generated and transmitted by the training units is responses to queries directed to an understanding of, and agreement to comply with, the safety rules and precautions.

15. The system of claim 12, wherein the qualifying data is directed to successful completion of testing associated with training directed to a specific job skill or task, the successful completion of the testing indicating an individual's competence in the specific skill or task, the qualifying data being a certification for the individual to perform the skill or task at the one or more site locations.

16. The system of claim 12, wherein the network clients are badging devices to generate a badge or identification card indicating that access to the one or more site locations is permissible for a respective individual.

17. The system of claim 12, wherein the network clients are recording devices to monitor and track individual access to the one or more site locations.

18. The system of claim 12, wherein the training units are personal computers and the network connection is the internet.

19. A computer system comprising:
a processor;
a memory coupled to the processor; and
a software deployment module which executes in the processor from the memory and which, when executed, provides training, qualifies individuals for employ, and provides indication of access to one or more site locations by:
receiving registration data directed to one or more participants desiring employ at and access to the one or more site locations and recording the data to the memory;
providing training directed to a relevant topic;
providing a qualifying interface configured to receive participant input relating to one or more queries directed to the relevant topic;
receiving the participant input relating to the one or more queries and recording the participant input to the memory;
transmitting results data evidencing a relative level of participant success to the one or more site locations; and
providing an indication of participant qualification for employment at and access to the one or more site locations, wherein the indication serves to enable the participant entry to the one or more site locations.

20. The system of claim 19, further comprising, after receiving the participant input relating to the one or more queries and before transmitting the results data, evaluating whether the participant input satisfies a predetermined criteria; wherein if the predetermined criteria is not satisfied, providing supplemental or repeated training directed to the relevant topic, including providing one or more supplemental or repeated queries directed to the relevant topic for participant input.

21. The system of claim 19, further comprising the step of transmitting direction to generate a badge or identification card, wherein the direction is based upon a review of the registration and the results data recorded to the central storage media for the participant, whereby the badge or identification card enables the participant to enter the one or more site locations.

22. The system of claim 19, further comprising the step of analyzing the indication serving to enable the participant to enter the one or more site locations, the registration data and the results data recorded to the central storage media and transmitting applicable data relevant to the analysis to the one or more site locations.

23. The system of claim 22, wherein the applicable data relevant to the analysis transmitted to the one or more site locations is an approval or disapproval for participant entry to the one or more site locations.

24. The system of claim 22, wherein the applicable data relevant to the analysis transmitted to the one or more site locations is selected from the group consisting of an approval or disapproval of participant entry to the one or more site locations, an indication of the participant's good standing, an indication of the participant's certifications, and an indication of the participant's limitations while on site.

25. The system of claim 19, further comprising the step of receiving, upon participant access to the one or more site locations, and recording to the central storage media, data selected from the group consisting of a site location identifier for the site location accessed by the participant, a time of entry, a time of exit, and tasks performed.

26. The system of claim 19, wherein providing indication of participant qualification for employment at and access to the one or more site locations occurs with each participant request for entry at the one or more site locations upon a review of the registration and the results data for the participant recorded to the central storage media.

27. The system of claim 19, wherein the relevant training topic is a safety orientation related to work at sanitation sites and the one or more site locations are landfills.

28. The system of claim 27, wherein the participant input related to the one or more queries is directed to an understanding of, and an agreement to comply with, mandatory and recommended safety precautions in place at the landfills.

29. The system of claim 28, wherein disagreement by a participant to three consecutive attempts to respond to a single query results in participant lock-out from continuing training.

30. The system of claim 19, wherein the relevant training topic is directed to a specific job skill or task, the queries are directed to testing competence in the specific skill or task, and the indication of participant qualification is a certification allowing the participant to perform the specific skill or task at the one or more site locations.

31. The system of claim 19, wherein transmitting results data evidencing a relative level of participant success to the one or more site locations includes indication of a participant's agreement or disagreement to comply with safety precautions in place at the site locations, the indication noting a number of disagreement responses of the participant prior to providing an agreement response.
